(19) United States
(12) Patent Application Publication
(10) Pub. No.: US 2026/0228799 A1
(43) Pub. Date: Aug. 6, 2026

(54) RECOMMENDATION METHOD AND RECOMMENDATION SYSTEM AND COMPUTER READABLE MEDIUM BASED ON INTEREST GRAPH

(71) Applicant: Inventec Appliances Corp., New Taipei City (TW)

(72) Inventor: Yong-Ping ZHENG, New Taipei City (TW)

(21) Appl. No.: 19/361,016

(22) Filed: Oct. 17, 2025

(30) Foreign Application Priority Data
Feb. 6, 2025 (CN) 202510132300.3

(51) Int. Cl. G06Q 30/0601

(52) U.S. Cl. CPC G06Q 30/06311

(57) ABSTRACT

A recommendation method, system, and non-transitory computer-readable medium are disclosed. The method comprises obtaining instant scene information of a user; obtaining recommendation needs of a user, generating a recommendation target based on a personalized interest graph model, the instant scene information, and one or more recommendation needs; and presenting the recommendation target in a scenario-based manner. The personalized interests of the user are generated based on historical behavior information and historical scene information of the user. The personalized interests are processed based on a knowledge graph of a large language model to generate the personalized interest graph model.

### RELATED APPLICATIONS

This is a U.S. Application, which claims priority to China Application Serial Number 202510132300.3, filed February 6, 2025, which is herein incorporated by reference.

### BACKGROUND

### Field of Invention

The present invention relates to information technology, and more particularly to a recommendation method based on an interest graph.

### Description of Related Art

Typically, personalized recommendation systems are widely used in e-commerce, social media and navigation services, leveraging user behavior and interest data to provide accurate recommendations. However, traditional approaches rely on historical user behavior, such as browsing, clicking, or purchase records, and use "things find people” or “people find things” models to directly recommend past items or recommend similar items based on similarity rules. Additionally, recommendations may also leverage friends’ behaviors and interests via social-network check-in mechanisms.

Although traditional recommendation methods meet users' explicit recommendation needs, they often lack immediacy and contextual relevance due to insufficient real-time integration of scene information (e.g., time, location, and environment). Taking electronic map recommendations as an example, the traditional recommendation technology mainly displays road traffic and geographic location information, such as surrounding attractions, shops, hotels, gas stations and parking lots, etc. These information is almost the same for any user at any time. Therefore, the traditional recommendation technology cannot reflect personalized interests or immediate scenario needs, such as navigation needs for various immediate activities, which not only reduces the relevance and accuracy of the recommendation results, but also limits the system's adaptability in complex scenarios, such as dynamic changes in user groups or environments.

Therefore, there is a need for a recommendation method to improve the immediacy, accuracy and diversity of recommended content.

### SUMMARY

The present invention aims to provide a recommendation method and system based on an interest graph, solving the inability of traditional methods to combine personalized interests with immediate scenes.

Another purpose of the present invention is to provide a recommendation method and a recommendation system based on an interest graph to solve the problem that the traditional recommendation methods are difficult to achieve joint recommendation in multi-person scenarios.

In one embodiment, the method comprises: obtaining instant scene information associated with a user; obtaining the recommendation needs of the user; generating a recommendation target using a personalized interest graph model based on the instant scene information and the one or more recommendation needs; and presenting the recommendation target in a scenario-based manner. The personalized interest graph model is generated by processing personalized interests of the user, derived from historical behavior and scene information, with a large language model based on a knowledge graph.

The generation of the personalized interest graph model includes: collecting user information including historical behavior and scene data; performing personalized description processing on the user information to form personalized interest description information; constructing a knowledge graph between scenes and interests based on the personalized interest description information; and obtaining the personalized interest graph model by processing the knowledge graph with a large language model (LLM) using Retrieval-Augmented Generation (RAG) technology.

In some embodiments, the step of performing personalized description processing on the user information to form personalized interest description information further comprises: pre-processing the user information for extracting interests, scenarios and interest score information to perform a unified description to form a structured personalized interest description data document.

In some embodiments, the step of constructing a knowledge graph between scenes and interests based on the personalized interest description information further comprises: performing text segmentation and document processing on the personalized interest description information to generate a preliminary knowledge graph; forming a final knowledge graph by generating an association relationship between scenarios and interests through a community detection algorithm; and visually displaying the constructed knowledge graph.

In some embodiments, pre-processing user information to extrac interests, scenarios and interest score information further comprises: using an interest classification library to classify different types of interest information; and dynamically adjusting the interest score based on scene condition information.

The interest score information is dynamically adjusted based on additional multi-dimensional information, including user behavior, tags and geographic locations, popularity, freshness, and social network information.

In some embodiments, presenting the recommendation target in a scenario-based manner further comprises: dynamically selecting the display format of the content of the recommended target based on the user’s context, including device hardware and device network conditions.

In some embodiments, presenting the recommendation target in a scenario-based manner includes dynamically selecting a display format of the content of the recommended target based on the priority of the interest-recommended content. The display format (e.g., text, pictures and videos) may be determined according to device capability, network status, or content priority.

In some embodiments, the step of obtaining the recommendation needs of the users, and using a personalized interest graph model in combination with the obtained instant scene information to process to generate a recommendation target further comprises: generating an enhanced prompt structure through multi-level information fusion to send to the personalized interest graph model; receiving from the recommendation target based on the enhanced prompt structure by the personalized interest graph model. The prompt is used to prompt the context of the input information for the large language model and the parameter information for the input model in the large language model.

In some embodiments, the step of obtaining the recommendation needs of the users, and using a personalized interest graph model in combination with the obtained instant scene information to process to generate a recommendation target further comprises: performing a full-text search on the original data used to generate the personalized interest graph model; and combining the search results with the preliminary generation results from the personalized interest graph model to generate a recommendation target.

The method further supports multi-person scenarios, including determining whether the current scene involves multiple users and obtaining authorization from each user (e.g., via Near Field Communication (NFC) touch between mobile terminals). A recommendation target is then generated based on the combined interests. For instance, an average interest recommendation method may be used if the users' needs are similar, while an optimal combined interest recommendation method may be used if their needs differ.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the steps of a recommendation method based on an interest graph according to an embodiment of the present invention.

FIG. 2 is a diagram showing the steps for generating a personalized interest graph model according to an embodiment of the present invention.

FIG. 3 is a diagram showing the steps of personalized description processing according to an embodiment of the present invention.

FIG. 4 is a diagram showing the steps for constructing a knowledge graph according to an embodiment of the present invention.

FIG. 5 is a schematic diagram of a knowledge graph according to an embodiment of the present invention.

FIG. 6 is a diagram showing the steps for making recommendations based on an enhanced prompt structure according to an embodiment of the present invention.

FIG. 7 is a diagram showing the steps for multi-person combination recommendation according to an embodiment of the present invention.

FIG. 8 is a schematic diagram of a knowledge graph according to another embodiment of the present invention.

FIG. 9 is a schematic diagram of a recommendation system according to some embodiments of the present disclosure.

### DESCRIPTION OF THE EMBODIMENTS

The following description enables those skilled in the art to make and use the disclosure and sets forth the inventor’s best modes. The description is illustrative and not intended to be limiting. Various modifications to the embodiments will be readily apparent to those skilled in the art.

Conventional recommendation systems often rely on static user data and fail to integrate dynamic, real-time scene information. This can result in recommendations that lack immediacy and situational relevance, particularly in multi-person scenarios. Embodiments of the disclosure address these limitations by providing a recommendation method and system based on a dynamically generated interest graph.

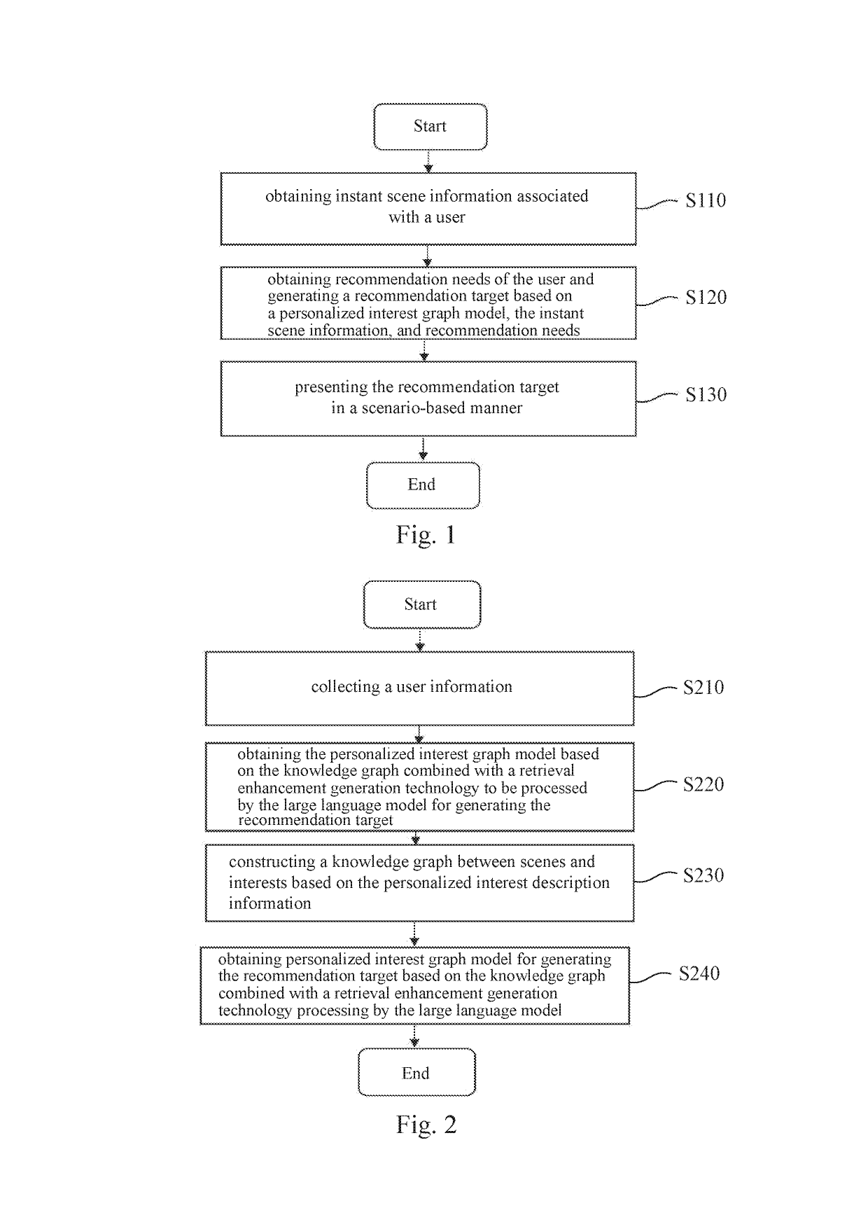

Referring to FIG. 1, a recommendation method comprises: obtaining instant scene information (S110); obtaining one or more recommendation needs of a user (S120); and generating a recommendation target based on the instant scene information and the recommendation needs using a personalized interest graph model (S120); and presenting the recommendation target in a scenario-based manner (S130). The disclosed recommendation method combines an offline process for generating the personalized interest graph model with an online process for instant recommendation. This hybrid approach creates a flexible and accurate recommendation process suitable for complex scenarios requiring personalization and multi-user collaboration.

FIG. 2 is a diagram showing the steps for generating a personalized interest graph model according to an embodiment of the present invention. As shown in FIG. 2, the generation process of the personalized interest graph model includes the following steps: collecting user information in step S210; performing personalized description processing on the user information to form personalized interest description information in step S220; constructing a knowledge graph between scenes and interests based on the personalized interest description information in step S230; obtaining a personalized interest graph model based on the knowledge graph combined with retrieval enhancement generation technology processing by a large language model for generating a recommendation target in step S240.

In this embodiment, the user information obtained in step S210 comprises historical behavior information and historical scene information. The information is collected from various sources, such as personal wearable devices, home medical devices, smart home devices, vehicle-mounted devices, Internet of Things (IoT) devices and medical institutions. The information collected by these devices includes behavioral information, physiological information, medical records and other scenario-related information. The user information includes behavioral information and scene information.

The behavioral information may include browsing history, click data, purchase records, and viewing history, reflecting a user’s potential interests. The scene information may include contextual data such as geographic locations, time, weather, device status, physiological information, and medical information.

The combination of the above information provides a comprehensive reference for user interest analysis and scenario adaptation.

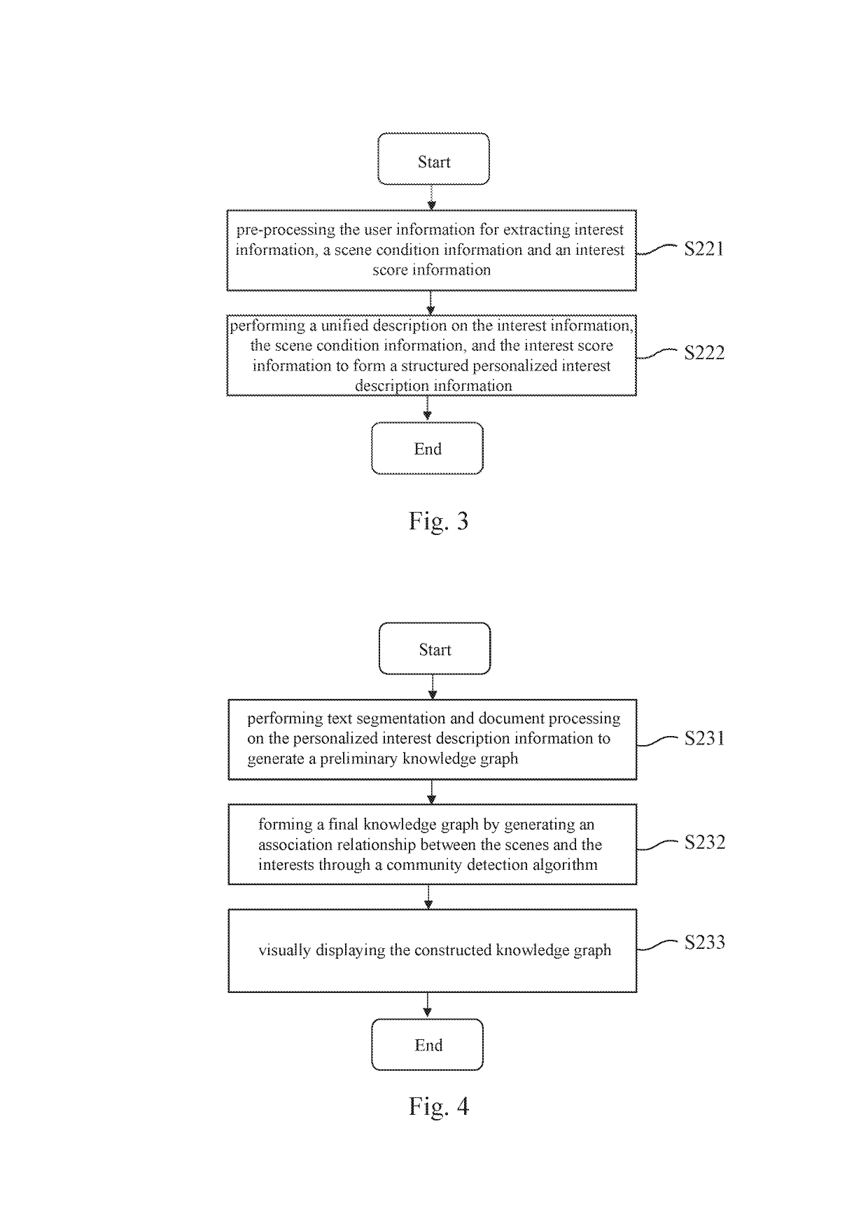

FIG. 3 is a diagram showing the steps of personalized description processing according to an embodiment of the present invention. As showing in FIG. 3, in some embodiments, the step S220 further comprises the following two sub-step: pre-processing the user information for extracting interest information, scene condition information and interest score information in step S221, and unified describing the extracted interest information, scene condition information and interest score information to form a structured personalized interest description data document in step S222.

More specifically, in step S221, the pre-processing process includes extraction operation, converting operation and loading operation. The user information is pre-processed by these operations to generate pre-processed related user information. The extracting interest information further comprises extracting specific interest points from behavioral information, such as product categories or services that the users like, to establish the relationship between user behavior and interests, and using an interest classification library to classify the extracted different types of interest information.

The extracting scene condition information further comprises extracting factors, such as time, location associated with the point of interest from the scene information, to establish a corresponding relationship between the scene and the interest, and clarifying the relationship between the interest and the scene.

An interest score is then determined. For example, the interest score may be classified into a plurality of levels (e.g., ”low interest”, ”medium interest”, ”high interest”, “extremely like” and “most like”) or thereby forming a grading system based on interest score conditions to ensure the accuracy and timeliness of the description. More specifically, in step S222, the extracted interest information, scene condition information and interest score information are uniformly described to generate a structured document.

The structured document contains knowledge graph information including personal ID which serves as a node, points of interest which serve as nodes, scene condition information and interest score which serve as edge relationships.

The extracted information is then formed into a structured data document. In one embodiment, this document represents a data structure that links a user identifier to one or more interests, associated scene conditions, and corresponding interest scores.

By extracting interest information and matching scene conditions, the step S220 realizes personalized description of user interests, and provides data basis for precise and scenario-based recommendations. Furthermore, the interest information is dynamically adjusted based on scene information combined with additional multi-dimensional information to ensure the accuracy and immediacy of the description are further improved.

More specifically, in step S222, the extracted interest information, scene condition information, interest score information and additional multi-dimensional information are uniformly processed to generate a structured document.

The additional multi-dimensional information includes, but is not limited to, user behavior information, tags (Hashtags), geographic location information, popularity information, freshness (timeliness) information, and user social network information. The user behavior information includes browsing, clicking, liking, commenting, collecting, purchasing, and other operations. The frequency, duration, and timing of these behaviors can reflect the strength of user interest. The tags and geographic location information refer to tag information related to geographic locations extracted from personal social media. The popularity information reflects the popularity of a certain interest point among the overall users. Combining popularity information with the user personalized interests can make recommended content more attractive. The freshness information must be combined with the temporal dimensions to reflect dynamic adjustment of interest score levels and user interests that change over time. User social network information can further reflect dynamic adjustment of interest scores through friend behavior on social networks and interaction frequency.

In this embodiment, the accuracy and adaptability of recommendations are improved by adding multi-dimensional information to integrate behaviors, scenarios, social networks, and popularity. The multi-dimensional factors are weighted and integrated to dynamically adjust the level of interest score.

FIG. 4 is a diagram showing the steps for constructing a knowledge graph according to an embodiment of the present invention. In step S231, the text segmentation step further comprises segmenting the personalized interest description information document generated in step S220 according to entities and relationships to form text units. In some embodiments, the entities comprise a user ID and points of interest. The relationships comprise scene condition and interest intensity.

The purpose of text segmentation is to extract important elements from the text and establish the correspondences between entities and relationships. The text segmentation step supports entity recognition and relationship mapping. These text units are the foundation for knowledge graph construction.

In step S231, the text processing step further comprises converting the text units into text vectorization representations to facilitate graph generation and modeling. The text vectorization representations are used for model training to improve the matching accuracy between points of interest and scenes.

The step of generating a preliminary knowledge graph further comprises performing entity recognition and relationship graph construction on the segmented and vectorized text to form a preliminary knowledge graph structure.

After segmenting and vectorizing text, a preliminary knowledge graph is constructed based on the segmented and vectorized text. In this process, the connections and associations between entities can be clarified by performing entity recognition and relationship graph construction to form the preliminary structure of the knowledge graph.

More specifically, in step S232, a community detection algorithm is used to generate associations between points of interest and scenes. The community detection algorithm comprises node aggregation method, edge weight adjustment method.

In some embodiments, the community detection algorithm is to identify node groups with similar attributes or relationships in the graph according to graph theory methods to generate association relationships between interest points and scenes based on node aggregation, edge weight adjustment.

Nodes with similar interests and scenes are grouped into the same "community" by the node aggregation method. The "community" is a group of interests and scenes. The strength of the association relationships between interest points and scenes are reflected by adjusting the edge weights in the graph. For example, a point of interest may show a stronger correlation in a specific scenario, and its weight in the graph will be larger.

The relationship between different communities is further optimized to enhance the quality of the graph to form the final knowledge graph by explicit methods, such as community segmentation methods, and implicit methods, such as embedding algorithms.

In some embodiments, community segmentation methods are to group nodes with similar interests in a graph into the same community, which can more clearly identify user groups with similar interests and their preferences.

In some embodiments, embedding algorithms are to map nodes and edges into vector space by low-dimensional space embedding methods, such as node2vec, Deep Walk, so that the relationship between nodes can be more accurately expressed in low-dimensional space, thereby optimizing the association relationship in the graph.

In step S232, information is extracted from low-dimensional to high-dimensional communities to generate a community summary report. The community summary report can be used to embed data to describe the potential connections and weighted relationships between different points of interest. In step S233, the final knowledge graph is presented in 2D or 3D format to intuitively show the complex relationship between user interest points, scene conditions and interest scores. Nodes represent community summary reports or users, and lines represent weighted relationships under different scene conditions.

The user interests described in the final knowledge graph not only include interest types, but also combine scene conditions and interest score levels.

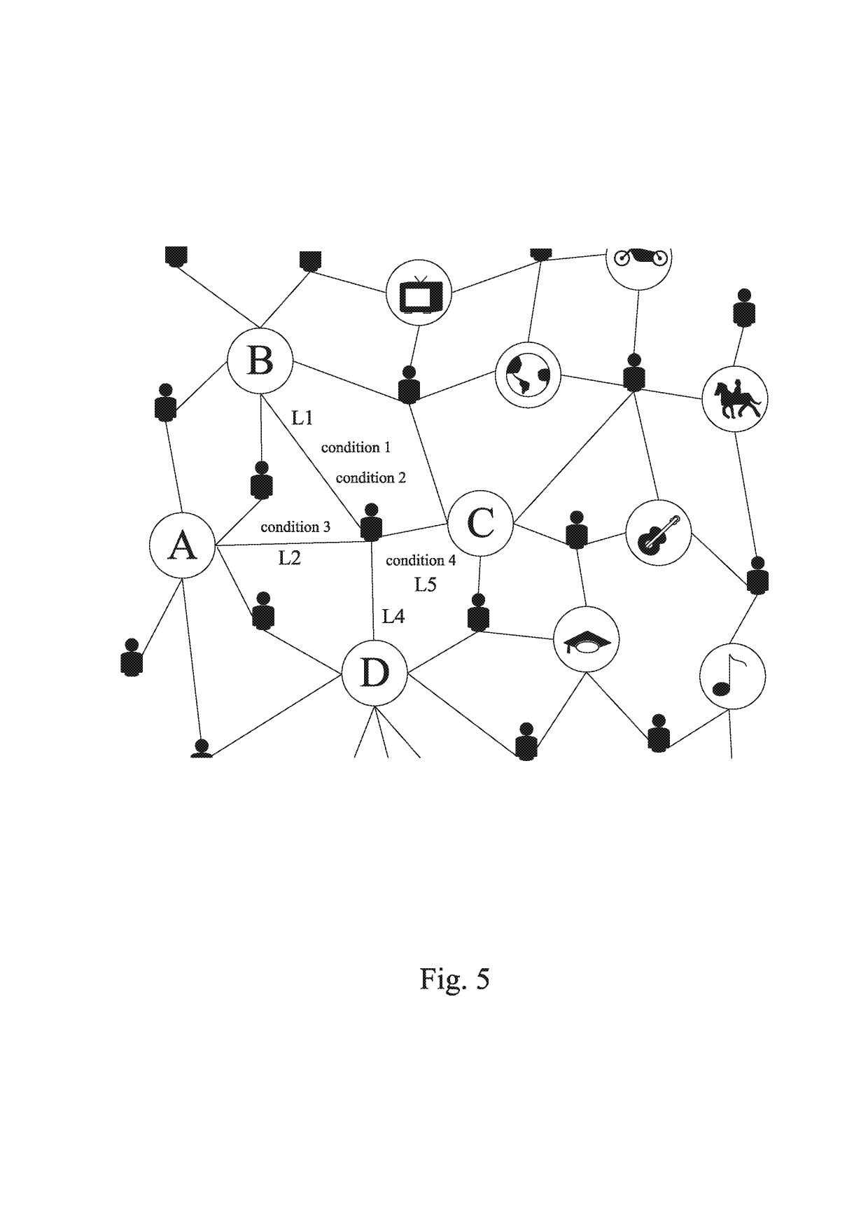

FIG. 5 is a schematic diagram of a knowledge graph according to an embodiment of the present invention. As shown in FIG. 5, the knowledge graph shows the relationship between interest nodes A, B, C and D, and describes the strength of the association relationship between user interest points and scenes by different scene conditions, condition 1, condition 2, condition 3 and condition 4, and connection weights L1, L2, L4 and L5. The core of the knowledge graph is the association network of "interest-scene-people".

The interest nodes A, B, C and D in FIG. 5 represent different points of interest of the user, such as favorite activities, content, or items. The condition 1, condition 2, condition 3 and condition 4 represent specific scenes or environments, such as time or geographical location. The connection weights L1, L2, L4 and L5 are weights of scene factors, which represent the weight relationship between the points of interest and the scene conditions to quantify the level of influence of different scenes on the interest. The quantified level of influence is reflected in the connection weights L1, L2, L4 and L5 in the knowledge graph.

A person's preference for a certain content under certain specific conditions can be dynamically derived by the association between interests and scenes. The weighting process for scene factors can give priority to display points of interest that are more relevant to the current scene to improve the recommendation effect. Different scene conditions, such as condition 1 and condition 2, may have different triggering effects on the same interest. The user's interest preferences under specific conditions can be further refined by weighting and combining scene conditions, so as to provide a more accurate basis for the recommendation algorithm in complex scenarios.

For example, in condition 4, the strength of the association relationship with interest C of the user may be higher than that of other conditions, which may affect the recommendation priority. In this embodiment, step S240 uses the constructed knowledge graph as an interest graph database and uses the retrieval-augmented generation (RAG) technology and a large language model to optimize and process the knowledge graph to obtain a personalized interest graph model based on the knowledge graph.

The knowledge graph has constructed a refined user interest and scene association network which contains interest points, scene condition information and quantitative interest score information by the above-recited steps.

Using RAG technology and a large language model with knowledge graphing capabilities to process knowledge graphs can further understand users' personalized interest expressions, thereby capturing user preference patterns and behavioral patterns. The RAG technology is to retrieve information related to the current problem or need from the knowledge graph database, and then inputs the retrieved information as context into the large language model to generate more accurate and relevant output.

Based on the personalized interest graph model generated above, a recommendation method based on an interest graph of the present invention comprises the step S110, the step S120 and the step S130. The step S110 is to obtain the instant scene information of the user. The instant scene information provides contextual information for subsequent recommendations to ensure that the recommendation target matches the actual environment of the user. The instant scene information, for example, includes geographic locations, time, device type, network status and so no.

The step S120 is to utilize the personalized interest graph model in combination with the acquired instant scene information to process to generate recommendation targets and generate demand questions based on the instant scene information and the user's interest background. These demand questions are related to user queries, demand expressions or interests. Recommendations are made based on these demand questions.

The demand questions are converted into a task suitable for processing by a large language model and combined with a personalized interest graph model for calculation and reasoning to generate recommendation targets, which ensuring that the demand questions can be processed and the generated recommendation targets meet the user's interests and needs.

The generated recommendation targets are prioritized according to the user's interest map and scene conditions. These recommendation targets will be sorted according to priority and displayed to users through an adapted interface or media to ensure that the recommended content meets user needs.

The step S130 is to dynamically select the presentation format of the recommended content to adapt to different scene conditions and user interests based on the user's immediate environment and needs.

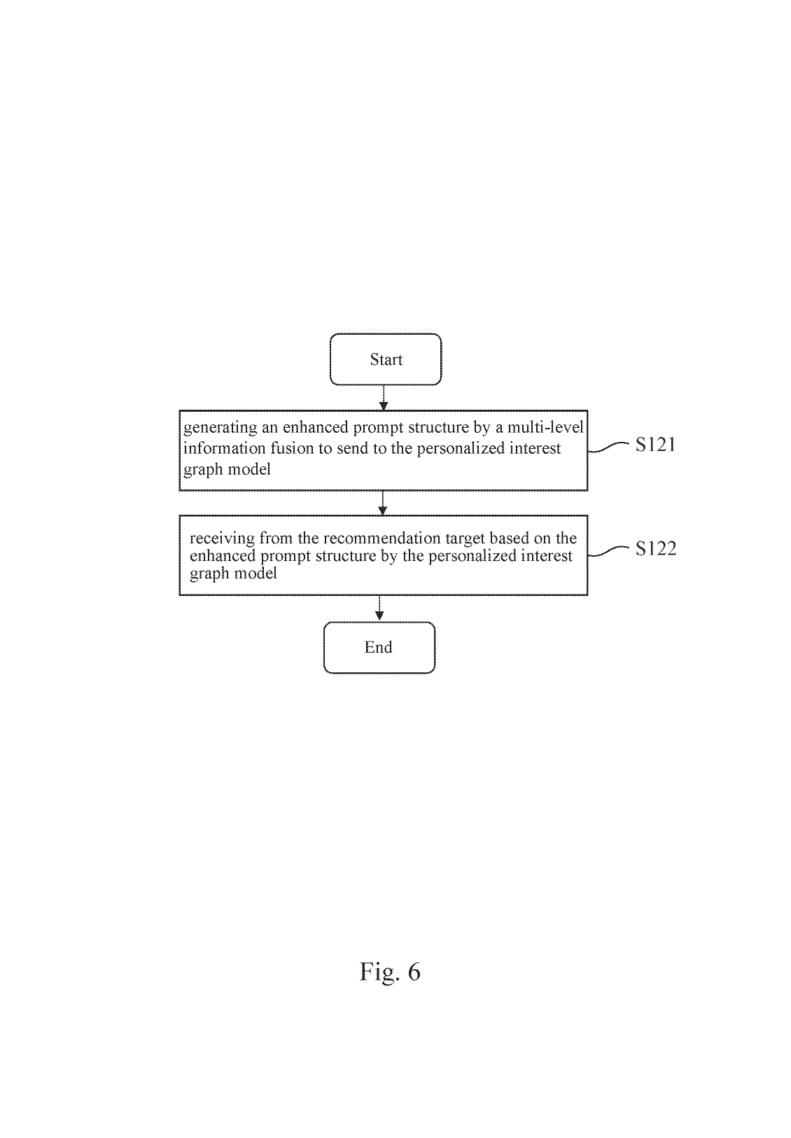

FIG. 6 is a diagram showing the steps for making recommendations based on an enhanced prompt structure according to an embodiment of the present invention. As shown in FIG. 6, in order to further improve the fit of the recommended content, step S120 comprises: generating an enhanced prompt structure through multi-level information fusion to send to the personalized interest graph model in step S121; and receiving from the recommendation target based on the enhanced prompt structure by the personalized interest graph model in step S122. The content of the recommendation target will meet the requirements of interest, scene conditions and prompt.

In some embodiments, an enhanced prompt structure is generated by integrating information of the initial question, interest graph content, current scene conditions. The enhanced prompt structure includes the initial question, the content of the query for interest graph content, the current scene conditions, the recommended content (interests), and the added answer conditions and format requirements, such as word limit, specific document format.

In order to improve the accuracy and comprehensiveness of the recommendation system, the step S120 introduces full-text retrieval. In one embodiment, a deep search is performed on the original data used to generate the personalized interest graph model. The search results are combined with the preliminary generation results of the personalized interest graph model. The combined results are uniformly processed by the personalized interest graph model to form a more complete and accurate recommendation target. In order to present the recommended content in a multi-dimensional manner, the step S130 further comprises dynamically selecting the display format of the content of the recommended target based on the device network conditions or device hardware conditions of the actual scenario in which the user is located.

In some embodiments, the user's immediate environment determines the display format of the recommended content. For example, when users use high-end devices and located in high-speed network environments, 3D or VR content will be displayed first. In contrast, when users use low-end devices and located in slow-speed network environments, only text or low-resolution images are displayed. When the network speed is low speed, such as 3G network environment, text or low-resolution images are displayed first. When the network speed is medium speed, such as 4G environment, high-definition videos or pictures can be presented. When network speed is high-speed networks, such as 5G/6G network environment, high-precision content, such as VR/AR experience, can be presented.

The step of presenting the recommendation target in a scenario-based manner comprises dynamically selecting the display format of the content of the recommended target based on the priority of the interest-recommended content.

In some embodiments, lower ranked interest recommendation contents are used as "second choice" for low priority recommended targets. Such interest recommendation content should be presented in the format of text-only or lightweight content, such as images without special effects, to reduce the demand on user devices and network bandwidth. The users' interest in the content can be gradually attracted in a simple and intuitive way by increasing user attention.

The top ranked recommended content is selected for high priority recommended targets. The top ranked recommended content is presented in the format of rich visual presentations such as videos, 3D animations or VR experiences. By sorting and highlighting, users can be attracted to pay attention. Provide more attractive content to attract users' attention and clicks.

In a multi-person scenario, the recommendation method based on interest graph proposed in the present invention also supports comprehensive recommendations based on the interests of a plurality of users. The specific process comprises determining whether the current scene is a multi-person scenario after obtaining recommendation needs (step S120); and comprehensively generating a recommendation target based on each person's personalized interest graph model combined with scene information when the current scene is the multi-person scenario.

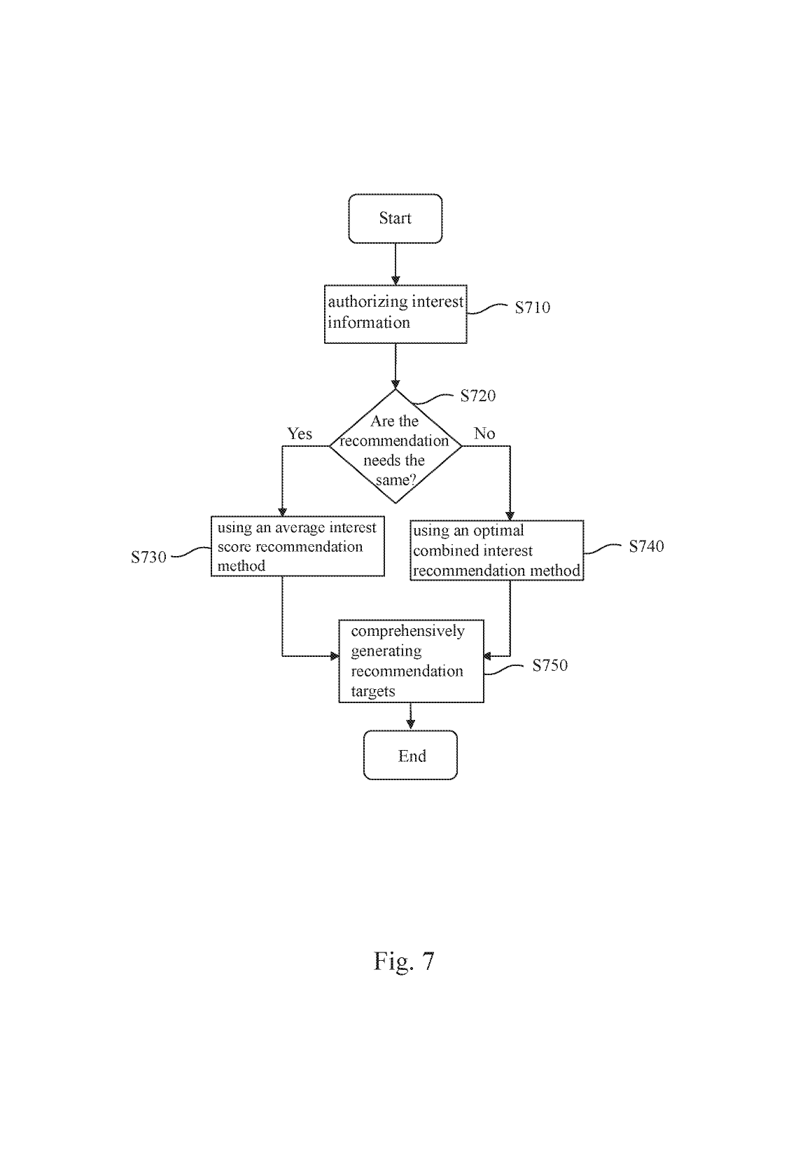

FIG. 7 is a diagram showing the steps for multi-person combination recommendation according to an embodiment of the present invention. Interest information authorization is first performed in step S710. To ensure information security, in a multi-person scenario, each user's interest information needs to be authorized. Only after the interest information authorization is completed, each person's personalized interest graph model can be obtained. Next, in step S720, whether the recommendation requirements of a plurality of persons are the same is determined. If the recommendation requirements of the plurality of persons are the same, then in step S730, an average interest score recommendation method is adopted to generate a common recommendation target by taking the average interest score of each person's personalized interest graph model.

If the recommendation requirements of the plurality of persons are different, an optimal combined interest recommendation method is adopted in step S740. Finally, in step S750, the optimal recommendation target is generated by comprehensively considering the optimal recommending target based on the interest score of each person's personalized interest graph model. After combining the respective scene conditions, the final recommendation strategy is selected to ensure that each person's interest needs can be met.

In this embodiment, the authorization of interest information is completed based on NFC touch of mobile terminals. The NFC touch authorization method can quickly obtain each person's personalized interest graph model. Mobile terminals include mobile phones and other portable devices.

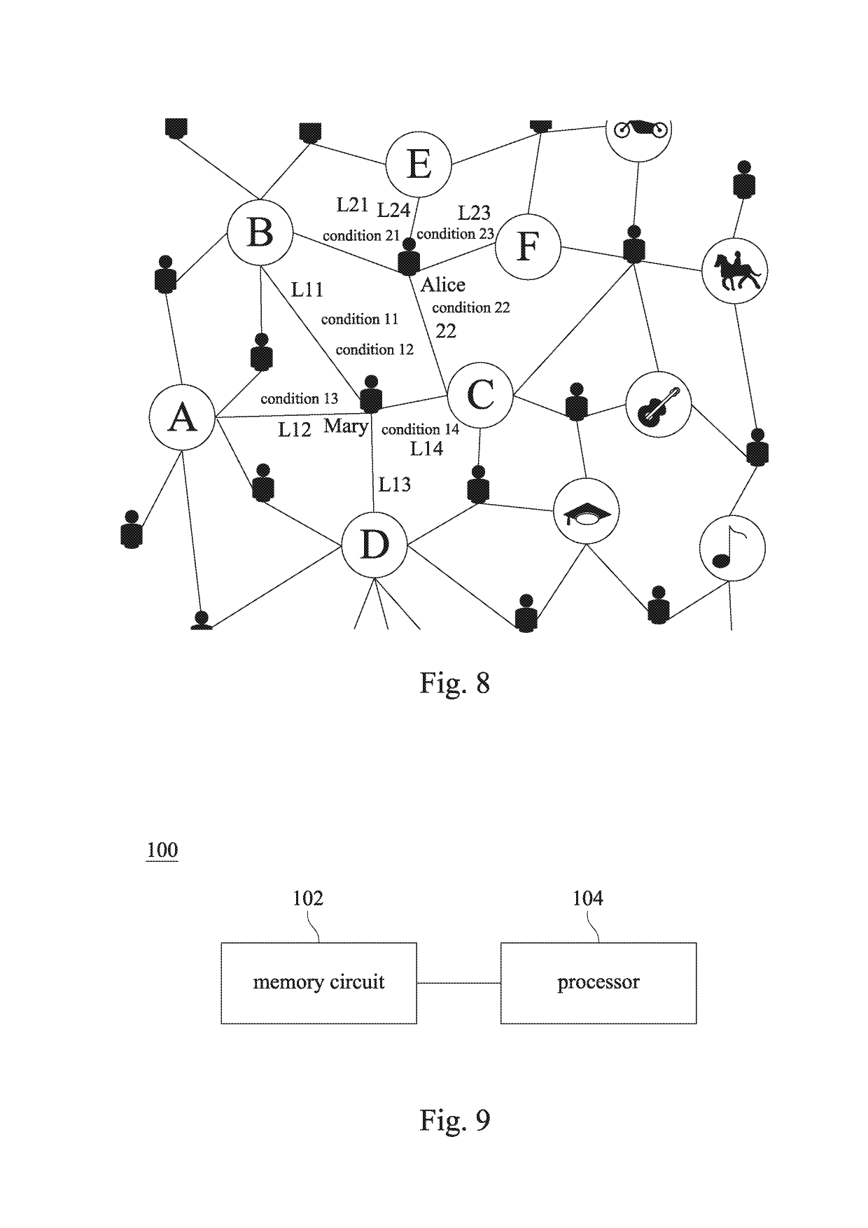

FIG. 8 is a schematic diagram of a knowledge graph according to another embodiment of the present invention. The knowledge graph combines Mary and Alice's interest points A, B, C, D, E and F and their associated scene conditions, condition 11, condition 12, condition 13, condition 14, condition 21, condition 22 and condition 23. The connection weights L11, L12, L13, L14, L21, L22, and L23 represent the weight of scene factors to quantify the relationship between interests and scenes to provide recommendation strategies in multi-person scenarios. The points of interest of Mary include node A, B, C and D. The points of interest of Alice include node B, C, E and F. Each node represents a different interest of the user, such as content, activity or object.

In the average interest score recommendation method, when Mary and Alice have common interests, such as node B and node, the average interest score of each person is taken to generate a recommendation target.

In some embodiments, the average interest score of the interest of node B and node C is calculated. The node with the largest average interest is selected as the optimal recommendation. For example, if the average interest score of node B is higher than that of node C, node B is recommended.

In the optimal combined interest recommendation method, when Mary and Alice have different interest, the optimal interest points are recommended for each of them, and a balanced recommendation strategy is selected based on the scene conditions. In some embodiments, the recommended target is node C for Mary. The recommended target is node F for Alice. Node C and node F are recommended for Mary and Alice, respectively. However, when considering scene conditions, such as condition 14 and condition 23, a weighted balanced recommendation is made for Mary and Alice.

For example, if the weight of node C is higher than that of node F in condition 14, node C is recommended first, otherwise, node F is recommended.

The present invention proposes a recommendation method based on an interest graph, which can self-adjust and identify personal interests and hobbies. The recommendation method based on an interest graph has the following beneficial effects: 1) by collecting user behavioral interests and comprehensively considering the scene factors of the user, such as time, place, weather, network environment, physiological characteristics, medical advice information), constructing an interest graph containing scene factor weights, it can display personalized content and recommend targets; 2) combining the behavioral interests of combined groups of people (such as besties, parents and children, friends), making reasonable target recommendations for the same and different interest needs, and presenting personalized content and recommending targets accordingly; 3) combining the real-time status of the recommended target, presenting the corresponding real-time recommended target (such as a real-time activity map) according to the user's interests, thereby realizing a personalized dynamic recommendation method.

The present invention also proposes a recommendation system. FIG. 9 is a schematic diagram of a recommendation system according to some embodiments of the present disclosure. As illustratively shown in FIG. 9, the recommendation system 100 for generating a recommendation target includes a memory circuit 102 and a processor 104. The memory circuit 102 stores a plurality of instructions that are used by the processing by the processor 104. For example, the processor 104 performs the instructions stored in the memory circuit 102 to realize the above-recited recommendation method.

Another aspect of the disclosure is directed to a non-transitory computer-readable medium storing instructions which, when executed, cause one or more computers to perform the above-recited recommendation method. The computer-readable medium may include volatile or non-volatile, magnetic, semiconductor, tape, optical, removable, non-removable, or other types of computer-readable medium or computer-readable storage devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer-implemented recommendation method comprising:
obtaining, by one or more processors, instant scene information associated with a user;
obtaining, by the one or more processors, one or more recommendation needs of the user;
generating, by the one or more processors, a recommendation target based on a personalized interest graph model, the instant scene information, and the one or more recommendation needs; and
presenting the recommendation target in a scenario-based manner,
wherein the personalized interest graph model is generated by processing a knowledge graph of personalized interests of the user with a large language model, the personalized interests being derived from historical behavior information and historical scene information of the user.

2. The method of claim 1, wherein generating the personalized interest graph model further comprises:
collecting a user information, the user information comprises the historical behavior information and the historical scene information;
performing a personalized description processing on the user information to form a personalized interest description information;
constructing the knowledge graph between scenes and interests based on the personalized interest description information; and
obtaining the personalized interest graph model based on the knowledge graph combined with a retrieval enhancement generation technology to be processed by the large language model for generating the recommendation target.

3. The method of claim 2, wherein the step of performing the personalized description processing on the user information to form the personalized interest description information further comprises:
pre-processing the user information for extracting interest information, a scene condition information and an interest score information; and
performing a unified description on the interest information, the scene condition information, and the interest score information to form a structured personalized interest description information.

4. The method of claim 2, wherein the step of constructing the knowledge graph between the scenes and the interests based on the personalized interest description information further comprises:
performing text segmentation and document processing on the personalized interest description information to generate a preliminary knowledge graph;
forming a final knowledge graph by generating an association relationship between the scenes and the interests through a community detection algorithm; and
visually displaying the constructed knowledge graph.

5. The method of claim 3, wherein the step of pre-processing the user information for extracting the interest information, the scene condition information and the interest score information further comprises:
using an interest classification library to classify different types of the interest information; and
dynamically adjusting the interest score information based on the scene condition information.

6. The method of claim 3, wherein the interest score information is dynamically adjusted based on the scene condition information combined with an additional multi-dimensional information comprises at least one of: a user behavior, a tag, and geographic locations, popularity, freshness, and a user social network information.

7. The method of claim 1, wherein the step of presenting the recommendation target in a scenario-based manner further comprises:
dynamically selecting a display format of a content of the recommended target based on device network conditions or device hardware conditions of actual scenario in which the user is located.

8. The method of claim 1, wherein the step of presenting the recommendation target in a scenario-based manner further comprises:
dynamically selecting a display format of a content of the recommended target based on priority of an interest-recommended content.

9. The method of claim 1, wherein the step of obtaining recommendation needs of the user, and using the personalized interest graph model in combination with the obtained instant scene information to generate the recommendation target further comprises:
generating an enhanced prompt structure by a multi-level information fusion to send to the personalized interest graph model; and
receiving from the recommendation target based on the enhanced prompt structure by the personalized interest graph model.

10. The method of claim 1, wherein after the step of obtaining recommendation needs of the user further comprises:
determining whether the scene of the user is a multi-person scenario; and
generating the recommendation target based on the personalized interest graph model of each person in the multi-person scenario combined with a scene information when the scene of the user is the multi-person scenario.

11. The method of claim 10, wherein the step of generating the recommendation target based on the personalized interest graph model of each person in the multi-person scenario further comprises:
generating an optimal recommendation target based on an average interest score recommendation method when recommendation needs of a plurality of persons in the multi-person scenario are the same; and
generating the optimal recommendation target based on an optimal combined interest recommendation method when the recommendation needs of the plurality of persons in the multi-person scenario are different.

12. The method of claim 10, wherein after the step of determining whether the scene of the user is a multi-person scenario further comprises:
authorizing interest information of a plurality of persons in the multi-person scenario when the scene of the user is the multi-person scenario; and
obtaining the personalized interest graph model of each person in the multi-person scenario.

13. The method of claim 12, wherein the step of authorizing interest information of a plurality of persons in the multi-person scenario further comprises:
authorizing interest information of the plurality of persons in the multi-person scenario based on a Near Field Communication(NFC) touch of mobile terminals of the plurality of persons.

14. A recommendation system, comprising:
at least one processor; and
a memory storing instructions that, when executed by the at least one processor, cause the at least one processor to perform the method of claim 1.

15. A recommendation system, comprising:
at least one processor; and
a memory storing instructions that, when executed by the at least one processor, cause the at least one processor to perform the method of claim 2.

16. A recommendation system, comprising:
at least one processor; and
a memory storing instructions that, when executed by the at least one processor, cause the at least one processor to perform the method of claim 3.

17. A recommendation system, comprising:
at least one processor; and
a memory storing instructions that, when executed by the at least one processor, cause the at least one processor to perform the method of claim 4.

18. A recommendation system, comprising:
at least one processor; and
a memory storing instructions that, when executed by the at least one processor, cause the at least one processor to perform the method of claim 5.

19. A recommendation system, comprising:
at least one processor; and
a memory storing instructions that, when executed by the at least one processor, cause the at least one processor to perform the method of claim 9.

20. A non-transitory computer-readable medium storing instructions that, when executed by at least one processor, cause the at least one processor to perform the method of claim 1.
